(19) United States
(12) Patent Application Publication
(10) Pub. No.: US 2009/0085862 A1
(43) Pub. Date: Apr. 2, 2009

(54) Video displaying apparatus

(75) Inventors: Kohichi Takaku, Shioya-gun (JP); Tetsuo Ikeyama, Yaita-shi (JP); Hideto Yagisawa, Yaita-shi (JP)

Correspondence Address: DAY PITNEY LLP, 7 TIMES SQUARE, NEW YORK, NY, 10036-7311, US

(73) Assignee: Sharp Kabushiki Kaisha

(21) Appl. No.: 12/283,932

(22) Filed: Sep. 17, 2008

Related U.S. Application Data
(60) Provisional application No. 60/997,007, filed on Sep. 28, 2007.

(51) Int. Cl. G09G 3/36

(52) U.S. Cl. 345/102

(57) ABSTRACT

A video displaying apparatus is provided that can change light-modulation rate of a backlight source in accordance with changes in a feature quantity of an input video signal based on a difference between times required for the light adaptation and the dark adaptation.

A video displaying apparatus includes a liquid crystal panel 3 that displays an input video signal, a backlight source 9 that applies light to the liquid crystal panel 3, an APL detecting part 6 that detects APL of the input video signal, and a control microcomputer 8 that variably controls a change amount of emission luminance of the backlight source 9 for each predetermined time based on the detected APL. The control microcomputer 8 performs control such that the change amount for the APL of the input video signal changing to a higher quantity becomes greater than the change amount for the APL of the input video signal changing to a lower quantity.

### TECHNICAL FIELD

The present invention relates to a video displaying apparatus applying light to a display panel such as a liquid crystal panel from a backlight source to display video and the video displaying apparatus dynamically changes a luminance of the backlight source depending on input video signals.

### BACKGROUND OF THE INVENTION

Video displaying apparatuses using liquid crystal panels to display video are widely used for video display in television receivers, computer apparatuses, etc. As is well known, a video displaying apparatus using a liquid crystal panel includes liquid crystal enclosed between two clear substrates provided with electrodes, controls a voltage of each drive electrode arranged in a matrix shape to control aggregation and orientation of liquid crystal molecules, and changes a transmission rate of light applied from a backlight source provided on the backside of the clear substrates to display video on the liquid crystal panel.

In a video displaying apparatus as described above, a luminance level of the backlight source can be set to a value adjusted through a manual operation (light modulation) by a user, and in this case, a luminance level of the backlight source is constant regardless of input video signals. On the other hand, to display more easily viewable images or to reduce power consumption, active-backlight-mode video displaying apparatuses are provided that dynamically adjust brightness of the backlight sources depending on input video signals changed any time for each screen. This mode may achieve improvement in a contrast ratio and reduction of power consumption.

For example, in a technology described in patent document 1, it makes possible to arbitrarily set time on a timer to start the control for a contrast value or backlight luminance value when display contents of video are switched to prevent flickering of screen in such scenes as video frequently switched.

However, the object of the technology described in patent document 1 is to achieve a constant display luminance when display contents of video are switched, and it is problematic that the black floating of video is not improved since a light source luminance may become high even though APL (average picture level) is low for dark scenes as in the case of movie software.

On the other hand, in technologies described in patent documents 2 and 3, a light source luminance is controlled to be reduced in dark scenes with low APL to enable prevention of occurrence of the black floating in video. In the case of patent document 2, when APL of the input video signal is within a range smaller than a predetermined threshold, a light amount applied to a display element is controlled to be a predetermined minimum level or nearby levels in this entire range.

In the case of patent document 3, change rates of the emission luminance may respectively be set for the cases of increasing and reducing the light-source emission luminance. Specifically, a change amount setting signal at the time of reducing the luminance is always set to a value larger than a change amount setting signal at the time of increasing the luminance to accelerate a change rate of the emission luminance when the light-source luminance is changed to a lower luminance as compared to when the luminance is changed to a higher luminance.

FIG. 6 is a block diagram of a configuration example of a video displaying apparatus described in patent document 3. The video displaying apparatus includes an APL detecting part 101, an intermediate control signal generating part 102, a signal change controlling part 103, a light-source drive part 104, a backlight source 105, a video signal processing part 106, a display element drive part 107, and a liquid crystal panel 108.

In FIG. 6, the video signal processing part 106 performs various video processing for an input video signal to generate a form suitable for a display format of display elements of the liquid crystal panel 108.

The display element drive part 107 drives the display elements of the liquid crystal panel 108 based on the video signal processed by the video signal processing part 106.

The APL detecting part 101 detects APL of the input video signal and outputs an APL signal to the intermediate control signal generating part 102.

The intermediate control signal generating part 102 generates an intermediate control signal changing in each unit field period in accordance with changes in APL and outputs the intermediate control signal to the signal change controlling part 103.

The signal change controlling part 103 controls the intermediate control signal sent from the intermediate control signal generating part 102 based on a set time constant and converts it into a signal having different change rates for the cases of increasing and reducing the light-source emission luminance and outputs the signal as a light-source control signal to the light-source drive part 104.

The light-source drive part 104 changes the emission luminance of the backlight source 105 based on the light-source control signal output from the signal change controlling part 103.

FIG. 7 depicts changes of the emission luminance of the backlight source with time in response to changes in APL in the video displaying apparatus shown in FIG. 6. FIG. 7(A) depicts changes in APL and FIG. 7(B) depicts changes of the emission luminance of the backlight source with time.

In this light modulation controlling method, the change rates of the emission luminance may respectively be set for the cases of increasing and reducing the emission luminance of the backlight source. In an example of FIG. 7(B), a change rate of the emission luminance is accelerated when the light-source luminance is changed to a lower luminance as compared to when the luminance is changed to a higher luminance. That is, when the light-source luminance is increased, the backlight emission luminance is slowly changed to the extent that a change in the luminance is not perceived by a user, and when the light-source luminance is reduced, the backlight emission luminance is changed relatively faster.

[Patent Document 1] Japanese Laid-Open Patent Publication No. 5-127608

[Patent Document 2] Japanese Laid-Open Patent Publication No. 2003-36063

[Patent Document 3] Japanese Laid-Open Patent Publication No. 2002-357810

### DISCLOSURE OF THE INVENTION

### [Problems to be Solved by the Invention]

However, in the case of the technology described in patent document 3, although no major problem is generated when the APL is rapidly reduced, a user visually recognizes a phenomenon that brightness changes slowly without changing video when the APL is rapidly increased, resulting in deterioration of video quality.

That is, when APL is high, the control is performed to increase the light modulation, and the high APL means that the major part of video has luminance components. Therefore, although brightness should be returned to original brightness in accordance with the timing of the video, if the light-modulation rate is slow when the emission luminance is increased as in the case of patent document 3, the backlight emission luminance remains low even though the video is displayed, and the video remains in the dark state.

Conversely, the low APL means that a black area occupies larger part of video, and in this case, it is actually black but the black part is slightly bright due to leak of light because of the characteristics of the liquid crystal panel. This reaches a level visible to viewers. Therefore, the light-source luminance is controlled to be reduced at dark scenes with low APL, and it is desirable to decelerate the light-modulation rate when the emission luminance is reduced to change brightness without causing viewers to recognize the change.

These problems are caused by factors including a difference between times required for the light adaptation and the dark adaptation of human eyes. When the APL is rapidly increased, human eyes are light-adapted to respond to the rapid change in brightness. Since time required for the light adaptation is extremely short as compared to time required for the dark adaptation, eyes are quickly adapted to the brightness. Therefore, when the backlight luminance change is slow when the APL is changed to a higher level, a viewer recognizes video in the middle of change in luminance and recognizes the change in brightness. As a result, quality of video is deteriorated and a viewer feels uncomfortable.

Although the light modulation rate of the backlight source may dynamically be changed in consideration of the difference between times required for the light adaptation and the dark adaptation to solve the problems, this is not implemented in the technologies described in patent documents 1 to 3.

The present invention was conceived in view of the above problems and it is therefore the object of the present invention to provide a video displaying apparatus capable of changing a light-modulation rate of a backlight source in accordance with changes in a feature quantity of an input video signal based on a difference between times required for the light adaptation and the dark adaptation.

### [Means for Solving the Problems]

To solve the problems, a first technical means of the present invention is a video displaying apparatus comprising a display panel that displays an input video signal, a backlight source that applies light to the display panel, a feature quantity detecting part that detects a feature quantity of the input video signal, and a light-source controlling part that variably controls a change amount of emission luminance of the backlight source for each predetermined time based on the detected feature quantity, the light-source controlling part performing control such that the change amount for the feature quantity of the input video signal changing to a higher quantity becomes greater than the change amount for the feature quantity of the input video signal changing to a lower quantity.

A second technical means is the video displaying apparatus of the first technical means, wherein the light-source controlling part determines a target luminance of the backlight source depending on the feature quantity of the input video signal and performs control such that the change amount until attaining the target luminance becomes greater than a predetermined amount when a set luminance set for the backlight source is lower than the determined target luminance.

A third technical means is the video displaying apparatus of the first or the second technical means, wherein the feature quantity of the input video signal is obtained from anyone of or a combination of two or more of an average luminance level, a maximum luminance level, a minimum luminance level, and a luminance distribution status of the input video signal.

### [Effect of the Invention]

According to the present invention, since a light-modulation rate of a backlight source may be changed in accordance with changes in a feature quantity of an input video signal based on a difference between times required for the light adaptation and the dark adaptation, video quality will not deteriorate in any video and, even if a scene is rapidly made brighter, a viewer does not recognize a change in brightness and does not feel uncomfortable.

### PREFERRED EMBODIMENTS OF THE INVENTION

Preferred embodiments of a video displaying apparatus of the present invention will hereinafter be described with reference to the accompanying drawings.

FIG. 1 is a block diagram of a configuration example of a video displaying apparatus according to one embodiment of the present invention. The video displaying apparatus of the embodiment includes a video signal processing part 1 that performs various video processing for an input video signal to generate a form suitable for a display format of display elements of a liquid crystal panel 3, and a liquid crystal controller 2 that outputs a liquid crystal signal to a gate driver 4 and a source driver 5 of the liquid crystal panel 3 based on the display video signal processed by the video signal processing part 1.

The video displaying apparatus includes an APL detecting part 6 that detects APL (average picture level) of the input video signal for each screen, a remote-controller light-receiving part 7 that receives an instruction signal input by a user using a remote controller (not shown), and a control microcomputer 8 that detects/analyzes the instruction signal received by the remote-controller light-receiving part to control a light-source driving part 10 such as an inverter circuit driving a backlight source 9 based on the APL detected by the APL detecting part 6.

In the configuration of FIG. 1, a display panel of the present invention corresponds to the liquid crystal panel 3; a feature quantity detecting part of the present invention corresponds to the APL detecting part 6; and a light-source controlling part corresponds to the control microcomputer 8 and the light-source driving part 10.

The video displaying apparatus of the embodiment may be either the direct backlight mode or the side-edge backlight mode, and the backlight source 9 may be achieved by using light-emitting diodes (LED), etc., as well as cold cathode fluorescent lamps (CCFL), which are currently used in general, or may be achieved by using these devices at the same time. The luminance controlling method of the backlight source 9 is not limited to the voltage (or current) control and of course the duty (emission pulse width) control may be employed.

A main characteristic part of the present invention is that the light modulation rate of the backlight source is changed in accordance with changes in the feature quantity of the input video signal based on a difference between times required for the light adaptation and the dark adaptation. Specifically, when the APL is rapidly increased, the light modulation rate of the backlight source 9 is accelerated and the emission luminance of the backlight source 9 is changed in accordance with changes in video such that a viewer does not recognize a change in brightness in the same video. On the other hand, when the APL is rapidly reduced, the light modulation rate of the backlight source 9 is decelerated to change brightness at such a rate that a viewer becomes unrecognizable to changes in brightness due to leak of light. Therefore, mismatch of video and brightness is made less visible to a viewer to improve the video quality.

In FIG. 1, the APL detecting unit 6 detects APL of an input video signal and outputs the detection result as an APL signal to the control microcomputer 8.

The control microcomputer 8 compares the APL signal sent from the APL detecting unit 6 with the previous APL signal to detect a change in the APL. The control microcomputer 8 determines a target luminance of the backlight source 9 and determines a change amount of emission luminance (hereinafter, emission luminance change amount) of the backlight source 9 for each predetermined time based on the change in the APL to output the target luminance and the emission luminance change amount to the light-source driving part 10.

The light-source driving part 10 changes the emission luminance of the backlight source 9 based on the target luminance and the emission luminance change amount sent from the control microcomputer 8.

FIG. 2 depicts changes of the emission luminance of the backlight source with time in response to changes in APL in the video displaying apparatus shown in FIG. 1. FIG. 2(A) depicts changes of APL and FIG. 2(B) depicts changes of the emission luminance of the backlight source with time.

The control microcomputer 8 determines the emission luminance change amounts such that the emission luminance change amount for the APL of the input video signal changing to a higher level becomes greater than the emission luminance change amount for the APL of the input video signal changing to a lower level. Therefore, as shown in FIG. 2(B), when the APL is rapidly increased, the light modulation rate of the backlight source 9 can be accelerated to shorten a change time Tr2, and when the APL is rapidly reduced, the light modulation rate of the backlight source 9 can be decelerated to elongate a change time Td2.

The control microcomputer 8 determines the target luminance of the backlight source 9 depending on the APL of the input video signal, and when the luminance of the backlight source 9 is lower than the determined target luminance, the emission luminance change amount is determined to become greater than a predetermined amount such that the luminance of the backlight source 9 is increased to the target luminance at an accelerated light modulation rate. This predetermined amount is, for example, a value preliminarily set for a change from the maximum luminance to the minimum luminance of the backlight source 9 based on a time (rate) required for the light adaptation. When the APL is rapidly increased due to this light modulation control, the light modulation rate of the backlight source 9 can be accelerated to complete the light modulation processing before a viewer is light-adapted.

According to the light modulation controlling method of the video displaying apparatus of the present invention, the light modulation rate can be changed between the cases of increasing and reducing the luminance of the backlight source to perform the light modulation control in accordance with changes in video. That is, as shown in FIG. 2, when the APL is rapidly increased, the light modulation rate is made faster than a conventional rate to cause the luminance of the backlight source to follow changes in video. Therefore, the light modulation control can be completed before a viewer is light-adapted and the luminance of the backlight source can be increased to the target level without a change in brightness visually recognized by the viewer in the same video.

FIG. 3 depicts a characteristic curve representing a relationship between APL of the input video signal and the backlight luminance. The horizontal axis indicates the APL in percentage (%), and when the entire screen of the displayed video is black, the APL is 0%, and when the screen is entirely white, the APL is 100%. The vertical axis indicates the emission luminance of the backlight source 9 in percentage (%), which is 100% when the backlight luminance is maximized, and the minimum luminance is generally controlled to about 10% to 20% at the time of backlight modulation.

FIG. 3 shows an example of a characteristic curve of backlight using cold cathode fluorescent lamps, and of course a characteristic curve different from FIG. 3 is generated when another light source is used such as LED and organic EL.

The control microcomputer 8 adaptively changes a drive voltage value (or current value) of the backlight source 9 for the average luminance level of the input video signal by reference to a look-up table using a built-in ROM (not shown) or through calculations using approximate functions. On this occasion, the control microcomputer 8 determines the target luminance of the backlight source 9 based on the APL/backlight luminance (brightness) characteristics shown in FIG. 3. That is, in the case of the example of the emission luminance control of the backlight source 9 based on FIG. 3, the emission luminance of the backlight source 9 is controlled to be raised as the APL of the input video signal increases such that the screen luminance is increased.

FIGS. 4 and 5 are explanatory flowcharts of an example of active backlight control of the video displaying apparatus of the present invention. It is assumed that the processing of this example is executed by the video displaying apparatus shown in FIG. 1, and in FIGS. 4 and 5, a light-modulation current value indicates a set value of the emission luminance currently set in the backlight source 9; a light-modulation target value indicates a target value of the emission luminance of the backlight source 9; the number of steps for an up-modulation indicates a change amount of the emission luminance setting value when the light modulation of the backlight source 9 is increased; and the number of steps for a down-modulation indicates a change amount of the emission luminance setting value when the light modulation of the backlight source 9 is reduced.

An example of an initial setting processing of the video displaying apparatus of the present invention will be described with reference to FIG. 4(A). The control microcomputer 8 of the video displaying apparatus sets a light-modulation setting value of the current video mode as a light-modulation current value (step S1). The video displaying apparatus includes a plurality of video modes and includes different light-modulation setting values for the respective video modes. In this case, the light-modulation current value is set as a light-modulation setting value depending on a video mode selected by a viewer with a remote controller, etc.

An example of a light-modulation target value setting processing of the video displaying apparatus of the present invention will be described with reference to FIG. 4(B). This processing is executed every 16 msec.

The control microcomputer 8 of the video displaying apparatus acquires APL (average picture level) of the input video signal (step S11), calculates a light modulation level corresponding to the acquired APL from the characteristic curve (APL/backlight luminance characteristics) shown in FIG. 3, and sets this level as a light-modulation target value (step S12)

An example of a light modulation processing of the video displaying apparatus of the present invention will be described with reference to FIG. 5. This processing is executed every 32 msec.

The control microcomputer 8 of the video displaying apparatus determines whether the light-modulation target value is greater than the light-modulation current value (step S21), and when it is determined that the light-modulation target value is greater than the light-modulation current value (in the case of YES), it is determined that the APL of the input video signal is changed to a higher level. In this case, the control microcomputer 8 sets the number of steps for the up-modulation as a light-modulation step amount (step S22).

The control microcomputer 8 adds the light-modulation step amount to the light-modulation current value and determines the result of the addition as the light-modulation current value (step S23). The determined light-modulation current value is set in the light-source driving part 10 (step S24). The light-source driving part 10 changes the emission luminance of the backlight source 9 based on the light-modulation current value (the target luminance and the emission luminance change amount) sent from the control microcomputer 8.

On the other hand, when it is determined at above step S21 that the light-modulation target value is not greater than the light-modulation current value (in the case of NO), the control microcomputer 8 determines whether the light-modulation target value is smaller than the light-modulation current value (step S25). When it is determined that the light-modulation target value is smaller than the light-modulation current value (in the case of YES), it is determined that the APL of the input video signal is changed to a lower level. In this case, the control microcomputer 8 sets the number of steps for the down-modulation as the light-modulation step amount (step S26) This number of steps for down-modulation is set to a value smaller than the number of steps for up-modulation.

The control microcomputer 8 then subtracts the light-modulation step amount from the light-modulation current value and determines a result of the subtraction as the light-modulation current value (step S27). The process goes to step S24 to set to the determined light-modulation current value in the light-source driving part 10. The light-source driving part 10 changes the emission luminance of the backlight source 9 based on the light-modulation current value (the target luminance and the emission luminance change amount) sent from the control microcomputer 8.

When it is determined at step S25 that the light-modulation target value is not smaller than the light-modulation current value (in the case of NO), the control microcomputer 8 determines that no change is generated since the light-modulation target value is equal to the light-modulation current value and the processing is directly terminated.

In the case of this example, the number of steps for the up-modulation and the number of steps for the down-modulation correspond to the change amounts of the emission luminance of the backlight source 9 per 32 ms and are assumed to satisfy a relationship of the number of steps for the up-modulation>the number of steps for the down-modulation. Therefore, the light modulation rate at the time of increasing the APL may be faster than the light modulation rate at the time of reducing the APL.

Although an average picture level (APL) of a detected area in the display screen is used as the feature quantity of the input video signal in the above mentioned embodiment, the present invention is not limited to this embodiment and may be configured to obtain and utilize a state (presence or amount) of peak luminance of a video signal of a certain area in the display screen for the luminance modulation of the backlight source.

The maximum and minimum luminance levels and the luminance distribution status (histogram) in a predetermined area (period) of one frame may be used for the feature quantity of the input video signal, or the backlight source emission luminance may variably be controlled based on a video feature quantity obtained from a combination of two or more thereof. The backlight source emission luminance may variably be controlled depending on the feature quantity of the input video signal and the tone correction control of the input video signal may be performed in conjunction with this control.

### BRIEF DESCRIPTION OF THE DRAWINGS

FIG. 1 is a block diagram of a configuration example of a video displaying apparatus according to one embodiment of the present invention;

FIG. 2 depicts changes of emission luminance of a backlight source with time in response to changes in APL in the video displaying apparatus shown in FIG. 1;

FIG. 3 depicts a characteristic curve representing a relationship between APL of the input video signal and the backlight luminance;

FIG. 4 is explanatory flowcharts of an example of active backlight control of the video displaying apparatus of the present invention;

FIG. 5 is an explanatory flowchart of an example of the active backlight control of the video displaying apparatus of the present invention;

FIG. 6 is a block diagram of a configuration example of a video displaying apparatus described in patent document 3; and

FIG. 7 depicts changes of emission luminance of a backlight source with time in response to changes in APL in the video displaying apparatus shown in FIG. 6.

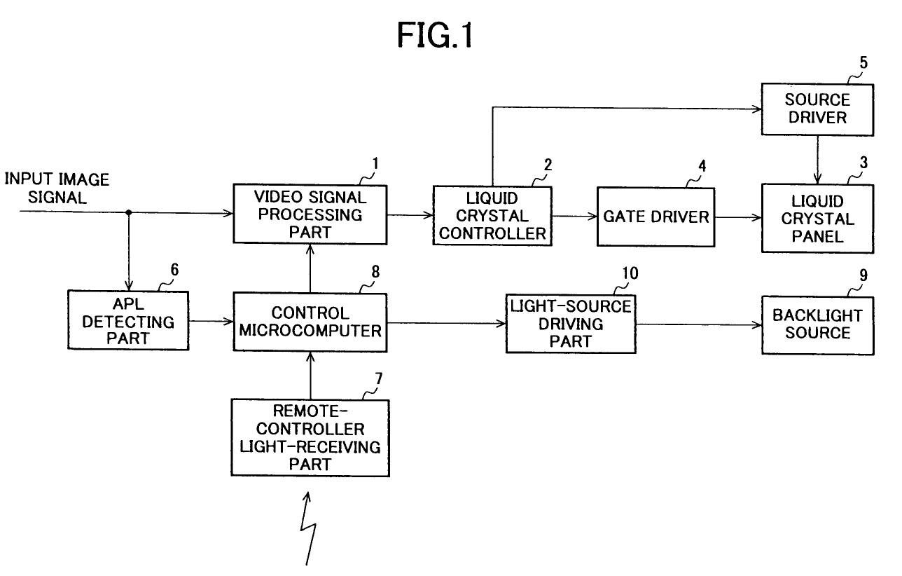

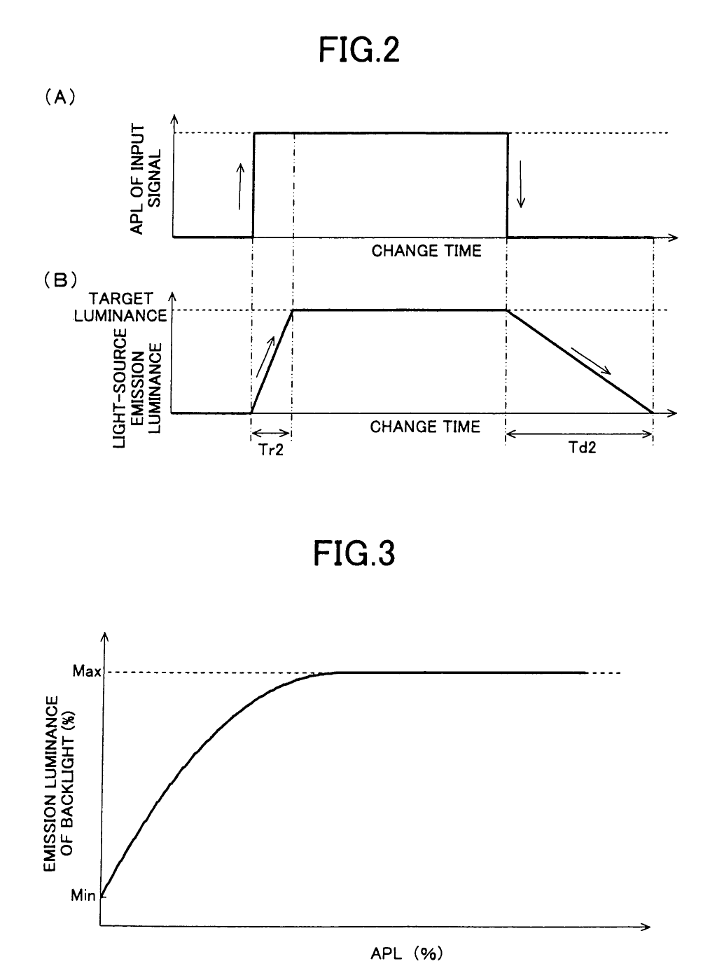

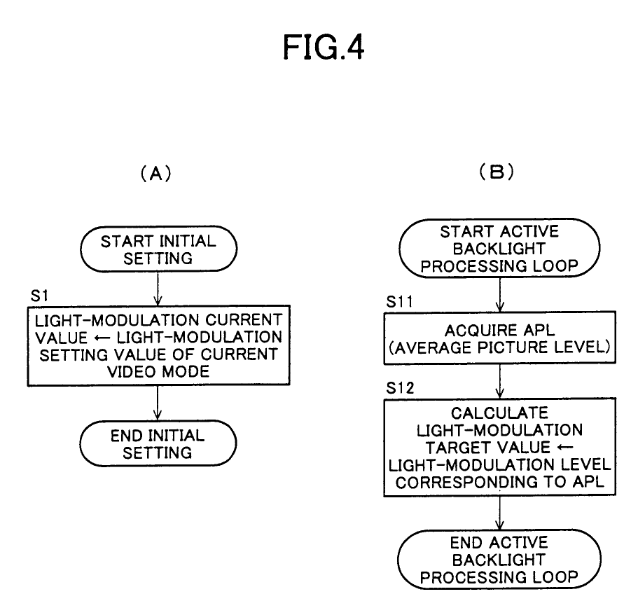

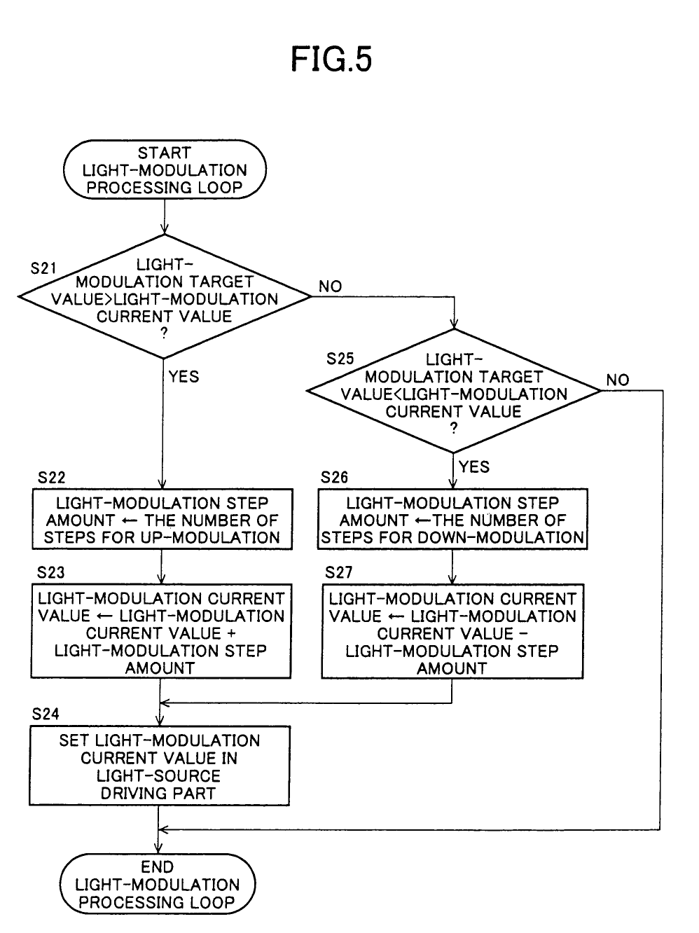

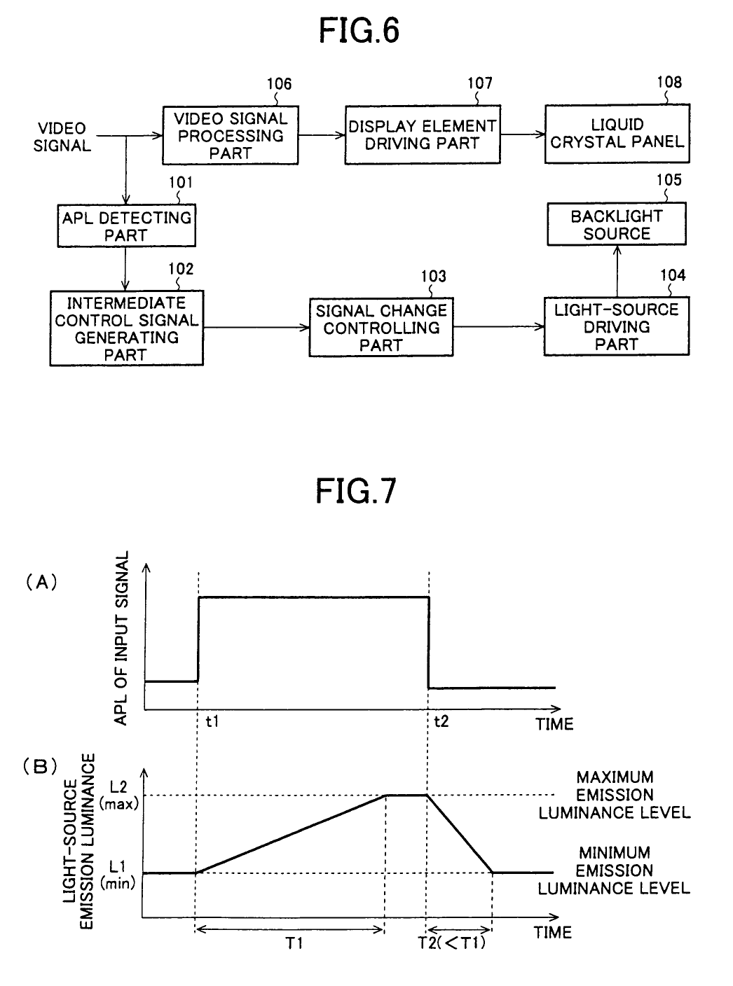

### EXPLANATION OF REFERENCE NUMERALS

1, 106 . . . video signal processing part; 2 . . . liquid crystal controller; 3, 108 . . . liquid crystal panel; 4 . . . gate driver; 5 . . . source driver; 6, 101 . . . APL detecting part; 7 . . . remote-controller light-receiving part; 8 . . . control microcomputer; 9, 105 . . . backlight source; 10, 104 . . . light-source driving part; 102 . . . intermediate control signal generating part; 103 . . . signal change controlling part; 107 . . . display element drive part.

1. A video displaying apparatus comprising a display panel that displays an input video signal, a backlight source that applies light to the display panel, a feature quantity detecting part that detects a feature quantity of the input video signal, and a light-source controlling part that variably controls a change amount of emission luminance of the backlight source for each predetermined time based on the detected feature quantity,
the light-source controlling part performing control such that the change amount for the feature quantity of the input video signal changing to a higher quantity becomes greater than the change amount for the feature quantity of the input video signal changing to a lower quantity.

2. The video displaying apparatus as defined in claim 1, wherein the light-source controlling part determines a target luminance of the backlight source depending on the feature quantity of the input video signal and performs control such that the change amount until attaining the target luminance becomes greater than a predetermined amount when a set luminance set for the backlight source is lower than the determined target luminance.

3. The video displaying apparatus as defined in claim 1 or 2, wherein the feature quantity of the input video signal is obtained from any one of or a combination of two or more of an average luminance level, a maximum luminance level, a minimum luminance level, and a luminance distribution status of the input video signal.
